(19) United States
(12) Patent Application Publication
(10) Pub. No.: US 2007/0235280 A1
(43) Pub. Date: Oct. 11, 2007

(54) Clutch-release device with a relubrication unit

(75) Inventor: Thomas Otto, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/711,278

(22) Filed: Feb. 27, 2007

(30) Foreign Application Priority Data
Apr. 11, 2006 (DE) 10 2006 016 911.5

(51) Int. Cl. F16D 23/14; F16N 11/10

(52) U.S. Cl. 192/98; 192/113.5

(57) ABSTRACT

A clutch-release device for a friction clutch installed in a housing in a vehicle includes a guide tube and a clutch-release bearing, which is free to shift position in the axial direction on the tube by means of a bearing carrier. One bearing ring of the clutch-release bearing is connected to the clutch-release element of the friction clutch to transmit the actuating force for actuating the friction clutch. The other bearing ring is mounted nonrotatably on the bearing carrier. For lubrication, the clutch-release bearing is provided with a relubrication unit provided with a freely controllable actuation unit for the as-needed lubrication of the clutch-release bearing.

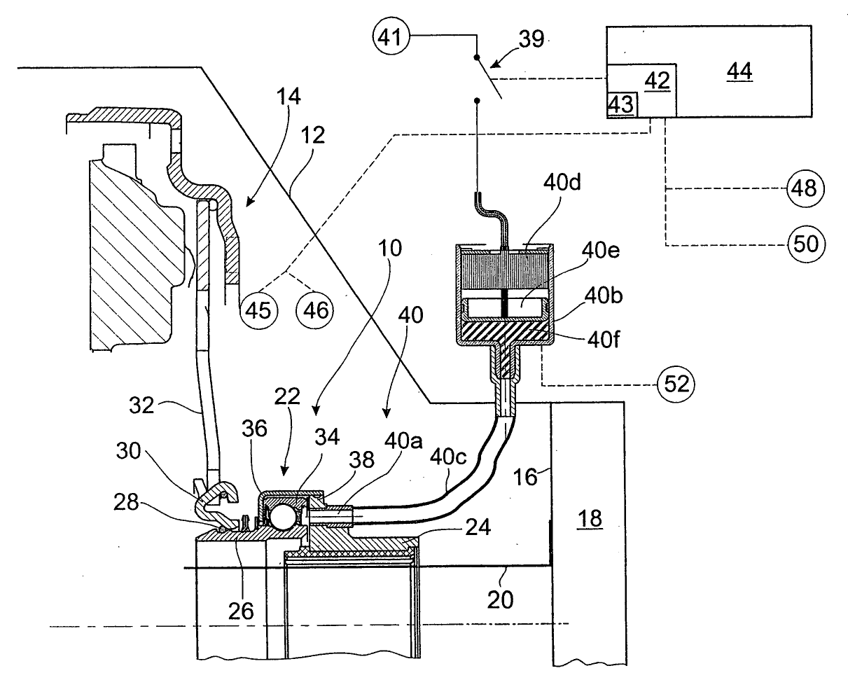

### BACKGROUND OF THE INVENTION

1. Field of the Invention

The invention pertains to a clutch-release device equipped with a relubrication unit for the clutch release bearing associated with the friction clutch of a motor vehicle.

2. Description of the Related Art

A clutch-release device of the general type in question for motor vehicle friction clutches is already known from U.S. Pat. No. 4,660,702. A lubricating nipple, which can supply the clutch-release bearing with lubricant through a channel, is screwed into the bearing housing of the clutch-release device presented here. Without opening the bell surrounding the friction clutch, however, it is impossible to tell in this design when the lubricant at the bearing has been used up. Relubricating the clutch-release bearing can therefore be done only as part of a maintenance procedure, which is scheduled to take place in advance either after a certain number of miles or after a certain period of time. For this purpose, however, the clutch bell must be removed. If the lubricant escapes from the bearing prematurely between two maintenance procedures, the bearing can run hot and be damaged so severely that it has to be replaced.

Another clutch-release device for a motor vehicle friction clutch is described in DE 102 29 746 A1. The bearing housing of this device includes a lubricant container, which is connected to the clutch-release bearing by a system of lubricant channels passing through a guide sleeve. The lubricant is transported to the clutch-release bearing through this system of channels as a function of the actuating pressure in the slave housing. Each time the friction clutch is actuated, the pressurized lubricant is conveyed in very small amounts into the channel system, where the amount of lubricant dispensed is determined by control edges. As a result, the clutch-release bearing is lubricated for life automatically and continuously. Because the lubricant container is integrated into the clutch-release device, additional space is required to accommodate the device. This space is not available in modern vehicle powertrains of compact design. According to this solution, furthermore, the bearing is relubricated even if this is not necessary or before it is necessary. Therefore, either the lubricant present in the reservoir is used up relatively quickly, or, to ensure continuous lubrication, the reservoir on the clutch-release device must hold an appropriately large volume of lubricant. With this solution, furthermore, it is impossible to determine from the outside when the supply of lubricant has been used up. The risk of insufficient or absent lubrication of the clutch-release bearing therefore remains, especially in the case of vehicles which are exposed to extreme heat and dirt.

### SUMMARY OF THE INVENTION

Against the background of the prior art described above, an object of the invention is to improve the clutch-release device of the type indicated above in such a way that lubrication of the clutch-release bearing is reliably guaranteed even under extreme conditions.

According to the invention, as-needed lubrication of the clutch-release bearing can be ensured by providing the relubrication unit with a freely controllable actuating unit. Thus relubrication can occur when necessary as a result of circumstances or when the need can be expected on the basis of special circumstances. A freely controllable relubrication unit guarantees thrifty use of lubricant and thus relatively low consumption. The lubricant container can be therefore designed with appropriately compact dimensions.

According to a preferred embodiment, the relubrication unit has a lubricant container, which is connected to the clutch-release device by a flexible lubricant line. As a result of the structural separation between the lubricant container and the device, the parts of the clutch-release bearing which are able to shift position during actuation of the clutch can also have a very space-saving design. Because the mass constituted by the lubricant container and the lubricant in it does not move concomitantly with the clutch-release bearing, furthermore, the advantage is obtained that the actuating force can be reduced to a minimum.

Because the lubricant container is installed outside the friction clutch housing, the lubricant supply can be easily checked without opening the friction clutch bell. In this way, it is possible to deal promptly with an impending shortage of lubricant.

The clutch-release bearing can, in principle, be relubricated by a manual actuating unit or by an automatic actuating unit, such as that described in for example, DE 10 2004 013 594 A1. The lubricant container in that document has a sliding piston, which can be pushed through the lubricant container by a gas generated by an electrochemical gas cell. The piston thus forces lubricant out of the lubricant container. As an alternative to a pneumatic actuator of this type, it would also possible to provide an electrical or hydraulic actuator for the piston. Actuators suitable for this purpose are known to the man of the art. An especially compact design of a relubrication unit can be obtained through the use of an electric motor, e.g., a stepping motor, which is connected to, for example, a gearbox and a spindle drive or screw drive and thus actuates the piston of a lubricant container designed in the form of a piston-cylinder assembly.

According to an advantageous embodiment, the actuating unit has an autonomous power supply. This is advantageous especially for retrofitting older vehicles, because there is no need to install complicated cabling to integrate the unit into the electrical system of the vehicle.

In cases where the relubrication unit is to be installed in a vehicle right from the beginning, it is advantageous for it to be supplied with power by the vehicle's own already existing electrical system.

Dispensing lubricant for the as-needed lubrication of the clutch-release bearing can be accomplished in various ways depending on the conditions under which the vehicle is operated. The actuating unit is thus provided with an electronic control unit to control the timing with which the lubricant is dispensed. Thus control unit can supply the lubricant under either open-loop or closed-loop control. The electronic control unit can be integrated into the relubrication unit, or it can be designed as a separate component belonging to, for example, the main vehicle control system.

For example, lubricant can be dispensed as a function of the number of hours the vehicle has been operated. This means, for example, that, during the period of time in which the ignition system of the vehicle is activated and possibly other vehicle-specific conditions are fulfilled, the electronic control unit monitors sensor data to establish if a predetermined state or actuation condition of the relubrication unit is satisfied. If the actuation condition is satisfied, the electronic control unit can cause an assigned timing element to activate the actuating element of the relubrication unit in a continuous or time-variable manner and thus to bring about the continuous or time-variable dispensation of lubricant. As soon as the actuation condition is no longer satisfied, the timing element and thus the relubrication unit are deactivated again. The electronic control unit can also be connected to, for example, a driving time meter or driving distance meter, especially an odometer, and activate the relubrication unit after the vehicle has been driven for a specified number of hours or has traveled a specified distance or after a certain interval between maintenance procedures has been completed.

Alternatively or in addition to a time-controlled system, the relubrication unit can also be designed to dispense lubricant on an event-controlled basis, where the electronic control unit comprises at least one sensor for detecting a certain state of the vehicle. In this respect, it is advantageous to install a temperature sensor on the clutch-release device or in its vicinity and to have the electronic control unit evaluate its signals. The relubrication unit can thus be activated whenever a predetermined limit temperature is reached, and the lubricant can be dispensed as long as this temperature is present. This can also be done in a time-controlled manner as explained above. When the temperature falls below the limit again, the relubrication unit can either be deactivated or switched to a time-controlled operating mode.

As an alternative or in addition to the previously described variants, furthermore, the relubrication unit can also be activated as a function of the wear of a friction clutch lining. For this purpose, a distance-measuring device can be integrated into a hydraulic clutch slave cylinder and connected to the electronic control unit of the relubrication unit. The signals can be evaluated, and if, as a result, a certain increment in the amount of wear is determined when the slave cylinder is in its end position, the relubrication unit can be activated a single time or for a certain period of time.

As an alternative or in addition to the proposed activation events, the intrusion of water or moisture into the housing of the friction clutch detected by means of a moisture sensor can also trigger the activation of the relubrication unit.

According to yet another advantageous embodiment of the invention, the lubricant container is designed as a replaceable container. In this way, an empty container can simply be removed and replaced by a full one. A special grease can be used which is different from the original grease, namely, a grease which is optimized for relubrication purposes or which is optimized for a certain type of vehicle deployment and which is compatible with mixtures.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The sole FIGURE is a schematic diagram of the relubrication system according to the invention.

### DETAILED DESCRIPTION OF THE PRESENTLY PREFERRED EMBODIMENTS

The sole figure shows a clutch-release bearing 10 for a friction clutch 14 of the pull type, only part of which is shown, installed inside a housing 12 in a vehicle. The clutch-release device 10 comprises a guide tube 20, attached to the wall 16 of a gearbox 18, and a sliding sleeve 24, which can shift position on the tube and which functions as a carrier for a clutch-release bearing 22. For the transmission of the force required to actuate the friction clutch 14, the inner bearing ring 26 of the clutch-release bearing 22 is in working connection with the clutch-release element of the friction clutch 14, designed as a diaphragm spring 32, by way of a load ring 28 and a clutch-release ring 30. The outer bearing ring 34 of the clutch-release bearing 22 is mounted nonrotatably by means of several retaining clamps 36 on a bearing flange 38 of the sliding sleeve 24.

So that the clutch-release bearing 22 can be relubricated, it is provided with a relubrication unit 40. This device has, first, a lubricant channel 40a, which passes axially through the bearing carrier, i.e., the sliding sleeve 24. Second, it has a lubricant container 40b, installed outside the housing 12, which is connected to the clutch-release device 10 by a flexible lubricant line 40c. The lubricant container 40b is designed as a replaceable container, so that, after it become empty, it can be removed and replaced with a full one.

For the as-needed lubrication of the clutch-release bearing 22, the relubrication unit 40 has a freely controllable and automatically operating actuating unit 40d, which, together with the lubricant container 40b, forms an assembled, detachable structural unit. The actuating unit 40d is designed in the form of an electromechanical piston-cylinder assembly, the piston 40e of which is driven by an electric motor acting by way of a screw drive. When activated, the piston conveys lubricant 40f from the supply container 40b into the flexible line 40c and from there to the clutch-release bearing 22.

For the controlled dispensation of lubricant, the actuating unit 40d is also connected to an electronic control unit 42, by means of which the actuating unit 40d is supplied with energy via a switching device 39 and thus activated in any desired manner. The electronic control unit 42 is, in the present example, designed as part of the main vehicle control system 44 and, like the actuating unit 40d, takes the electrical energy necessary for operation from the vehicle's on-board electrical system 41. With respect to its functionality, the electronic control unit 42 is designed for universal application. For the time-controlled dispensation of a lubricant, it comprises, first, a timer element 43, which allows the control unit to activate the actuating unit 40d to dispense lubricant at scheduled times or at predetermined time intervals. Alternatively or in addition to time control, furthermore, the electronic control unit 42 can be designed for the event-controlled dispensation of lubricant, for which purpose this unit is connected by a signal line to at least one sensor for detecting a certain state of the vehicle. In the present exemplary embodiment, the control unit 42 is connected for this purpose to a temperature sensor 45, installed inside the clutch bell 12 and to a moisture sensor 46, also installed there. Signals can also be exchanged through appropriate connections with a driving time meter 48 and with a driving distance meter 50 of the vehicle. Thus, as a result of the design explained above, it is possible for lubricant to be dispensed in a controlled manner in many different ways, such as that described by way of example above.

The functional unit formed by the actuating unit 40d and the lubricant container 40b also comprises a level indicator 52, which can signal the driver either visually or acoustically that the lubricant supply is getting low and should be replenished.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch release device for a friction clutch installed in a housing in a vehicle, the device comprising:
a guide tube;
a bearing carrier which is axially movable on the guide tube;
a release bearing comprising an inner ring and an outer ring, one of said rings being fixed against rotation with respect to said sliding sleeve, the other of said rings being in working connecting with a clutch release element; and
a lubrication unit arranged to lubricate said bearing, said lubrication unit comprising an actuating unit arranged to supply lubricant to said bearing as needed.

2. The clutch release device of claim 1, wherein the lubrication unit comprises a lubricant container and a flexible lubricant line connecting said container to said bearing.

3. The clutch release device of claim 2 wherein the lubricant container is installed outside the housing.

4. The clutch release device of claim 1 wherein the actuating unit is automatic.

5. The clutch release device of claim 1 wherein the actuating unit comprises an autonomous energy supply.

6. The clutch release device of claim 1 wherein the actuating unit is powered by the electrical system of the vehicle.

7. The clutch release device of claim 1 further comprising an electronic control unit assigned to the actuating unit to control the supply of lubricant.

8. The clutch release device of claim 7 wherein the electronic control unit comprises a timer for supplying lubricant at predetermined points in time.

9. The clutch release device of claim 7 wherein the electronic control unit comprises at least one sensor for generating a signal to indicate a state of the vehicle, said actuating unit supplying lubricant to said bearing in accordance with said signal.

10. The clutch release device of claim 2 wherein the lubricant container is a replaceable container.
